(19) United States
(12) Patent Application Publication
(10) Pub. No.: US 2019/0172037 A1
(43) Pub. Date: Jun. 6, 2019

(54) PRIVACY PROTECTION IN FINANCIAL TRANSACTIONS CONDUCTED ON MOBILE PLATFORMS

(71) Applicant: QUALCOMM Incorporated, San Diego, CA (US)

(72) Inventor: Jeremy Robin Christopher O'DONOGHUE, Wokingham (GB)

(21) Appl. No.: 15/829,858

(22) Filed: Dec. 1, 2017

(51) Int. Cl. G06Q 20/20; G06F 21/62; G06Q 20/32

(52) U.S. Cl. CPC G06Q 20/206; G06F 21/6245; G06Q 20/202; G06Q 20/3278; G06Q 20/204

(57) ABSTRACT

Systems and methods for protecting privacy and security of information transmitted from a card device to a Point of Sale (POS) device during a financial transaction. The POS device may obtain payment information comprising private information from the card device and implement one or more filtering rules to prevent the private information from being accessed by unauthorized applications on the POS device. For a Near Field Communication (NFC) based transfer of payment information from the card device to the POS device, the one or more filtering rules may be implemented in an NFC Controller Interface (NCI) Filter Application having one or more Privacy Management Gates to prevent the private information from being transferred out of the NFC Controller to an unauthorized reader.

### FIELD OF DISCLOSURE

Disclosed aspects are directed to protection of private user information in financial transactions using mobile devices. More particularly, exemplary aspects are directed to protecting a user's personal information and payment card details in a mobile device configured as a Point of Sale (POS) terminal for a financial transaction.

### BACKGROUND

The use of mobile communication devices such as contactless payment cards and devices which embed or integrate payment technology (e.g., smart phones, tablets, wearable devices, etc.) for financial transactions has become popular. For instance, owners of such devices (generally referred to as Cardholders) can make payments to other parties (such as Merchants) in a simple and seamless manner using an ever increasing array of mobile payment technologies.

To accept the payment by these mobile payment technologies, (e.g., by a Merchant), special purpose devices such as dedicated terminals or devices (e.g., dongles) which are connectable to a mobile communication device are known in the art and referred to herein as Point of Sale (POS) devices. Stringent security measures are expected of the POS devices to maintain the Cardholder's private information safe and secure. Security problems may arise in the POS devices for legacy reasons, wherein, certain sensitive information can be obtained by any contactless reader device. For example, it is possible to read out private information such as a primary account number (PAN), name of the Cardholder, expiry date, etc., in plaintext from a contactless payment card by a potentially unfriendly device in communication with the POS device or an application on the POS device. Such private information may be used to make fraudulent transactions (e.g., Cardholder Not Present (CNP) transactions) using the Cardholder's financial information.

For at least the above reasons, it is desirable to ensure that a general purpose device which can be used as a mobile POS device offers mechanisms which prevent the sensitive information from being read by other devices or by other applications running on the general purpose device.

### SUMMARY

Exemplary aspects of the invention include systems and method directed to protecting privacy and security of information transmitted from a card device to a Point of Sale (POS) device during a financial transaction. The POS device may obtain payment information comprising private information from the card device and implement one or more filtering rules to prevent the private information from being accessed by unauthorized applications on the POS device. For a Near Field Communication (NFC) based transfer of payment information from the card device to the POS device, the one or more filtering rules may be implemented in an NFC Controller Interface (NCI) Filter Application having one or more Privacy Management Gates to prevent the private information from being transferred out of the NFC Controller to an unauthorized reader.

In one exemplary aspect, the one or more filtering rules comprise filtering the private information when a SELECT command is initiated by an unauthorized reader application on the POS device, wherein the SELECT command is provided to the card device to access a Proximity Payment Service Environment (PPSE) application on the card device for determining an Application Identifier (AID) of the payment information and a File Control Information (FCI) Template is received from the PPSE application on the card device, wherein the FCI Template comprises the private information. Implementing the one or more filtering rules may comprise, for a SELECT command issued by an unauthorized reader, blocking one or more AIDs to be returned to the unauthorized reader. In one aspect, the one or more filtering rules comprises, filtering contents of a “Track 2 Equivalent Data” Tag Length Value (TLV) issued from an unauthorized reader application.

Accordingly, an exemplary aspect is directed to a method of protecting private information in a Point of Sale (POS) device, the method comprising obtaining, at the POS device, payment information comprising private information from a card device, and implementing one or more filtering rules at the POS device to prevent the private information from being accessed by unauthorized applications on the POS device.

Another exemplary aspect is directed to an apparatus comprising a Point of Sale (POS) device in communication with a card device, wherein the POS device is configured to obtain payment information comprising private information from the card device, and implement one or more filtering rules to prevent the private information from being accessed by unauthorized applications on the POS device.

Another exemplary aspect is directed to an apparatus comprising means for performing a Point of Sale (POS) transaction, comprising means for obtaining payment information comprising private information from means for storing payment information, and means for implementing one or more filtering rules at the means for performing the transaction to prevent the private information from being accessed by unauthorized applications on the means for performing the POS transaction.

Yet another exemplary aspect is directed to a non-transitory computer-readable storage medium comprising code, which, when executed by a processor, causes the processor to perform operations for protecting private information in a Point of Sale (POS) device, the non-transitory computer-readable storage medium comprising: code for obtaining, at the POS device, payment information comprising private information from a card device, and code for implementing one or more filtering rules at the POS device to prevent the private information from being accessed by unauthorized applications on the POS device.

### BRIEF DESCRIPTION OF THE DRAWINGS

The accompanying drawings are presented to aid in the description of aspects of the invention and are provided solely for illustration of the aspects and not limitation thereof.

FIG. 1 illustrates aspects of a conventional system for Point of Sale financial transactions.

FIG. 2 illustrates an example communication between a Point of Sale reader device and a card device.

FIG. 3 illustrates an exemplary set of fields for a mobile Point of Sale (mPoS) Kernel on a Point of Sale device which contain sensitive information.

FIG. 4 illustrates aspects of an exemplary system for Point of Sale financial transactions, according to aspects of this disclosure.

FIG. 5 illustrates an example rule set for filtering according to aspects of this disclosure, expressed in JavaScript Object Notation (JSON) code.

FIG. 6 illustrates aspects of a discovery mechanism used by a Host to read filtering rules, according to aspects of this disclosure.

FIG. 7 illustrates a method of protecting private information in a Point of Sale device, according to exemplary aspects of this disclosure.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Aspects of this disclosure are directed to filtering sensitive and private user information in processing systems configured for POS applications. A POS device configured for accepting contactless payment, for example, includes a Near Field Communication (NFC) controller for receiving information, e.g., wirelessly, from a mobile payment device. Exemplary rules are applied to NFC Controller Interfaces (NCIs) to detect and filter out private information, e.g., received during the course of accepting a payment, from leaving the NCIs. The various filtering rules and their implementations will now be discussed in detail with reference to the figures.

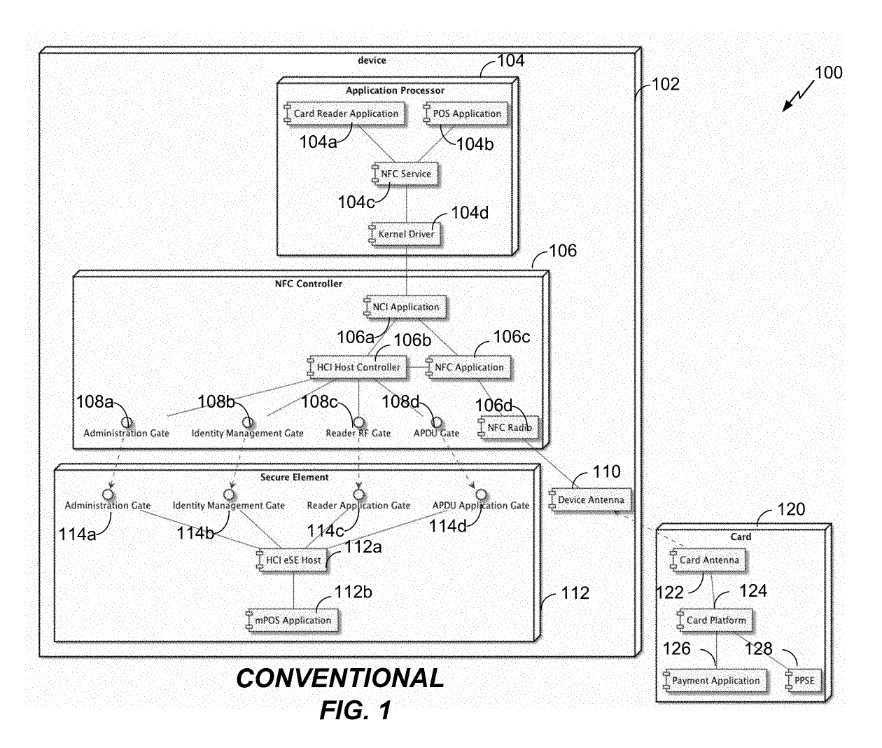

With reference to FIG. 1, a conventional NFC system 100 is shown, with two main functional blocks labeled device 102 and Card 120. Device 102 may be a multi-purpose device containing one or more processors such as a general purpose processor or a special purpose processor (e.g., a digital signal processor (DSP)) which may be configured, e.g., in combination, to act as a POS device. Card 120 may be any payment device, which may be used to initiate or conduct a financial transaction by communicating with device 102. For instance, card 120 may be a contactless card or mobile device configured to use one or more payment instruments such as credit cards, debit cards, virtual currency, etc., for making payments on behalf of a Cardholder or user. While device 102 and Card 120 have been separately illustrated in a physically disjointed manner, it will be understood that their functionalities may be realized in alternative implementations. In some examples, device 102 and Card 120 may communicate wirelessly (e.g., NFC communication, Bluetooth communication, any radio frequency (RF) communication, etc.), and as such, device antenna 110 and card antenna 122 have been respectively shown in device 102 and Card 120 to facilitate such communication. Payment information may be transmitted from Card 120 through card antenna 122 which may be received by device antenna 110 to be processed by device 102 configured as a POS device in some aspects.

The following subsystems or components of device 102 are shown: application processor 104, NFC controller 106, device antenna 110, and secure element 112, while keeping in mind that various other components which may also be present but are not particularly relevant to this disclosure have not been illustrated. Application processor 104 may be configured to run applications (e.g., which may be downloaded from an “App Store” as known in the relevant art). Components and example applications of application processor 104 have been shown in FIG. 1. For processing payments, POS Application 104b may be provided in application processor 104, wherein POS Application 104b may be used by a Merchant when device 102 is used for payment acceptance.

Also shown is Card Reader Application 104a, which is designed to read the contents of cards such as Card 120 (e.g., NFC cards placed within the “near field” of device 102 to enable reading the information from Card 120). As will be explained in further detail, Card Reader Application 104a may enable malicious attacks on sensitive information which may be retrieved from Card 120. For instance, private information read from Card 120 using Card Reader Application 104a may be retrieved or stolen by unauthorized agents such as other applications (not shown) which may be residing on Application Processor 104.

The two applications, Card Reader Application 104a and POS application 104b, may make use of a common NFC Service 104c configured to provide a standard Application Programming Interface (API) used by the various NFC applications on device 102 and specifically application processor 104. In an example configuration shown, NFC Service 104c may send messages via Kernel Driver 104d to NFC Controller 106.

NFC Controller 106, in more detail, includes NCI Application 106a which is an endpoint for communications with NFC Service 104c. NCI Application 106a may interpret the messages coming from NFC Service 104c and dispatch them to the NFC Application 106c or to Host Controller Interface (HCI) Host Controller Application 106b as appropriate. NFC Application 106c may be configured to manage contactless communications with other contactless devices such as Card 120 using NFC Radio 106d which is coupled to device antenna 110.

HCI Host Controller Application 106b may be configured to manage and provide communications between endpoints on NFC Controller 106 and Secure Element 112. In this regard, HCI Host Controller Application 106b is provided with a number of endpoints, referred to as “gates”, wherein the gates of HCI Host Controller Application 106b may be connected to Gates on another Host such as HCI eSE Host 112a in Secure Element 112 by means of logical communication channels, referred to as “pipes”. Specifically, Administration Gate 108a, Identity Management Gate 108b, Reader RF Gate 108c, and Application Protocol Data Unit (APDU) Gate 108d may be provided in NFC Controller 106, with counterpart Gates including Administration Gate 114a, Identity Management Gate 114b, Reader Application Gate 114c, and Application Protocol Data Unit (APDU) Application Gate 114d provided in Secure Element 112.

Secure Element 112 may include one or more applications, also referred to as “applets”. An example application or applet shown as a mobile Point of Sale (mPOS) application 112b may provide security-related functions pertaining to Point of Sale transactions, wherein mPOS application 112b may communicate with components external to Secure Element 112 via HCI eSE Host 112a.

As previously mentioned, device 102 may communicate using contactless or wireless protocols (e.g., NFC) with Card 120, wherein card antenna 122 may couple with device antenna 110 during communication. Card Platform 124 coupled to card antenna 122 may include radio functionality, a processor and an operating system (e.g., based on JavaCard with GlobalPlatform extensions, but which may be differently configured in some aspects). Card 120 may also include Payment Application 126 which communicates with PPSE 128. Payment Application 126 may contain sensitive or secret information which uniquely and securely identifies the Cardholder (e.g., a PAN, expiration date, Cardholder's name, etc.). PPSE 128 provides mechanisms whereby an mPOS Application such as mPOS Application 112b can discover information about the Payment Application applets or applets on a Card such as Card 120. Card 120 may be any device such as a Smartphone or Wearable device configured to make payments.

Secure Element 112 and Card 120 are typically expected to provide a high level of security to protect secret information that they respectively contain. In particular, a degree of tamper resistance is expected, but such high security requirements are not essential for other system components of device 102, such as other applications on Application Processor 104 (keeping in mind that to the extent that the requirement for tamper resistance is met for the functions within these components Secure Element 112 and Card 120, other system partitioning is possible).

A basic operating scheme of a contactless payment will now be described, e.g., as specified by standards such as ISO/IEC 7816, EMVCo, ETSI SCP, GlobalPlatform and others. Applications residing on contactless cards such as Card 120 are executed by an external reader such as NFC Controller 106 by first “SELECTing” the application by an Application Identifier (AID) and then sending commands to the SELECTed application. The scheme used in application identification for payments according to the above-mentioned standards specifies that different AID values are to be used by different payment products.

The AID of any contactless application consists of two parts: a Registered Application Provider Identifier (RID), which identifies Application Providers, e.g., providers offering international IC card applications, and may be issued by the ISO/IEC 7816-5 Registration Authority (TDC Services A/S), and a Proprietary Application Identifier Extension (PIX) which enables the Application Provider to differentiate between the different applications, e.g., different international IC cards, offered. The RID, may be a 5-byte Application provider identity and the PIX may be of variable length, up to 11-bytes.

In general, the RID may identify the general payment provider (e.g. Visa, Mastercard, etc.) and the PIX may be used to identify the issuer of the card and the type of the card. Accordingly, a relatively small number of RID values are likely to be used on commercially deployed payment cards, but the different combinations of PIX mean that the set of all AID values that can be used for payment is large. As a consequence of this, there is no single AID that can be SELECTed by a reader wanting to use a card to execute a payment.

Therefore a specific service discovery application called the Proximity Payment Service Environment (PPSE) 128 may be used, which is an application residing on Card 120 and which allows a reader such as device 102 to determine the AID (and order of user preference) of the payment applications residing on Card 120.

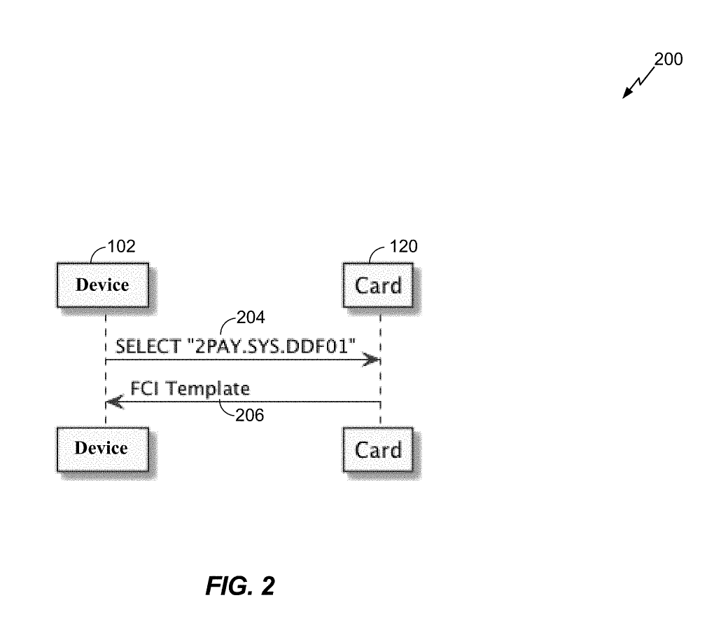

With reference to FIG. 2, an example operating sequence 200 of the PPSE 128 is shown, between a reader which may be generally device 102 per FIG. 1 and Card 120. Reader or device 102 may send a SELECT “2PAY.SYS.DDF01” command 204 as shown to Card 120 upon which, the File Control Information (FCI) Template 206 returned from Card 120 to device 102 lists “Directory Entries” for each of the payment applications on Card 120. These Directory Entries contain information including the AID of each payment application and the order of user preference for its usage in a well-defined format.

Once reader or device 102 has a list of the available payment applications, it selects the most preferred application that device 102 supports and performs an operating sequence. The operating sequences differ between payment schemes, and are well known in the art. For reasons of backward compatibility, each of the payment schemes offers mechanisms permitting a fallback to the use of data which was used on older magnetic stripe cards. Device 102 can obtain this information pertaining to the fallback data using a READ RECORD operation on the appropriate location in a particular file. While specific implementations may vary between kernels, the literature defining the format of the data using the READ RECORD operation is well known and available in the public domain, which means that a malicious agent, once it knows the AID of a payment application, can obtain sensitive information from the Directory Entries by specifying the known location using a READ RECORD, without authorization. Thus, private information supplied by Card 120 may be compromised by malicious agents.

Accordingly, aspects of this disclosure are directed to preventing unauthorized reader applications from obtaining sensitive information about Payment applications from cards (e.g., Card 120) being used for payment on general purpose devices (e.g., device 102) supporting POS functionality. In some aspects, general purpose reader applications may be prevented from running on devices such as device 102.

In one exemplary aspect, it is recognized that the main, but not only, mechanism for identifying payment applications is through the PPSE (e.g., PPSE 128) because a malicious reader application would otherwise need to try to SELECT a large number of different AIDs before finding a payment application on Card 120. Accordingly, the content of the FCI template 206 returned by PPSE 128 when PPSE 128 is SELECTed by a Reader Application running on the Application Processor 104 of reader or device 102 is filtered by exemplary filtering mechanisms provided on POS devices, to disallow sensitive information from being available to malicious reader applications on Application Processor 104.

In another exemplary aspect, it is recognized that there is a known set of RID values for payment applications of tractable size, and accordingly, unauthorized reader applications are prevented from SELECTing one or more specified RIDs of these known set of RID values.

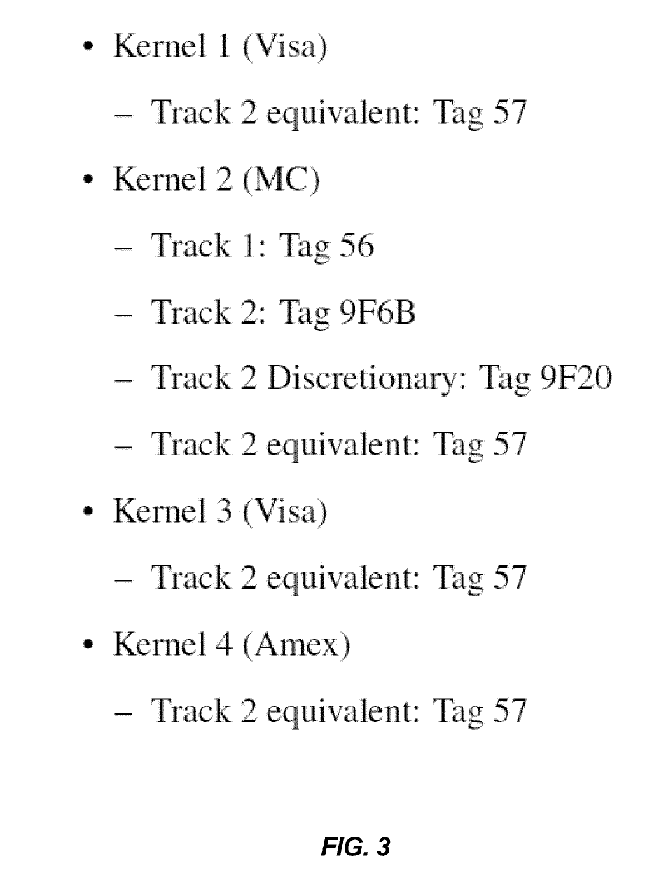

In yet another aspect, the one or more filtering rules which may be implemented can include, filtering contents of a “Track 2 Equivalent Data” Tag Length Value (TLV) issued from an unauthorized reader application. For instance, the contents of a “Track 2 Equivalent Data” Tag Length Value (TLV) object, when used from an unauthorized reader application may be prevented from being accessed. This is possible because the same Basic Encoding Rules (BER) TLV (or BER-TLV) scheme for identifying data objects and Tag values is used by all of the different payment kernels implemented on a Kernel running in mPOS Application 112b, for example, for this information. As shown in FIG. 3, which illustrates, among other fields, the Track 2 equivalents for various mPOS Kernels 1-4 for different payment providers, mPOS Kernels 1-4 all use the same BER-TLV Tag “57” to identify sensitive information. Thus, if an unauthorized reader application does not receive the BER-TLV Tag, then it may be prevented from reading sensitive information obtained from Card 120 by an NFC Controller.

Aspects of this disclosure involve provision of privacy gates to be applied to communication with NFC Service 104c, wherein the communication may involve POS transactions. In the well-understood NFC Controller Interface (NCI) protocol, the exemplary aspects may be applied by filtering a poll-side ISO-DEP RF Interface, as will be further explained below.

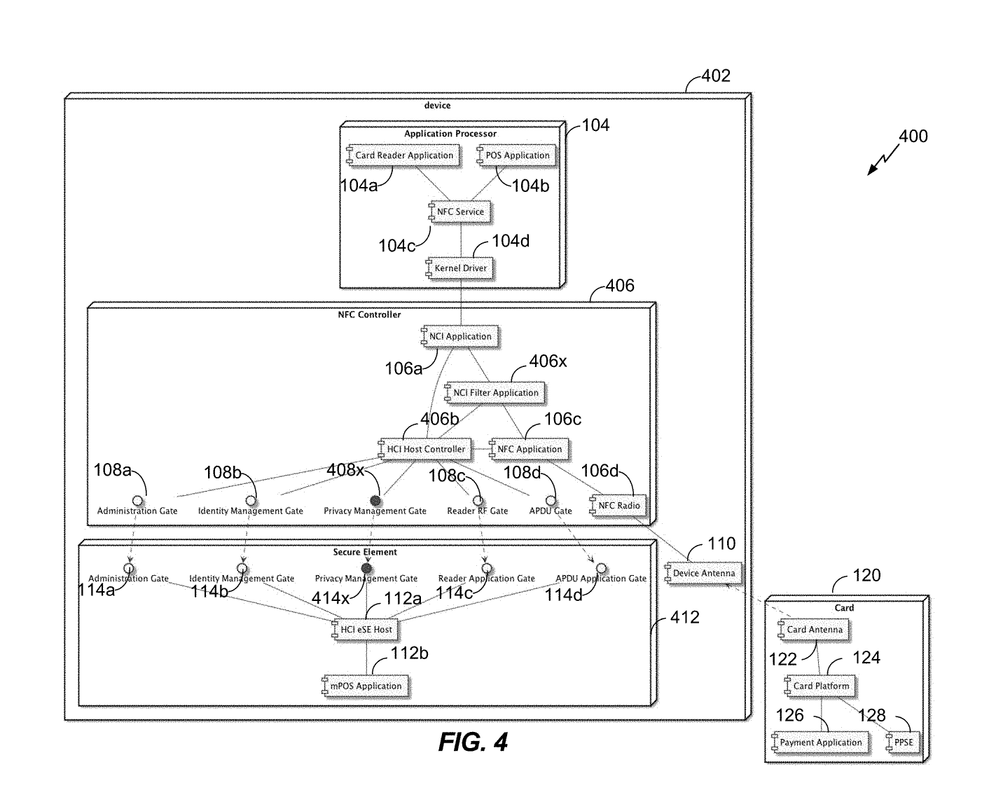

FIG. 4 illustrates an exemplary NFC system 400, which includes improvements to the NFC system 100 of FIG. 1 for achieving the protection of private information as discussed above. Like reference numerals have been maintained for similar components of NFC systems 100 and 400, and for the sake of brevity, the description of the common components between these systems will not be repeated. Focusing on the improvements, NFC system 400 comprises device 402 (e.g., a means for performing a POS transaction) in communication with Card 120 (e.g., a means for storing payment information), wherein device 402 includes NFC controller 406 and Secure Element 412 configured with Cardholder privacy protection enhancement. Specifically, NCI Filter Application 406x is shown in NFC Controller 406 (although it will be understood that a similarly configured functional block for filtering may be located elsewhere, such as within Kernel Driver 104d or NFC Service 104c without deviating from the scope of this disclosure). NCI Filter Application 406x may include means for implementing one or more filtering rules according to this disclosure. For instance NCI Filter Application 406x may be configured to implement or enable the exemplary filtering mechanisms for privacy protection in this disclosure. More specifically, NCI Filter Application 406x is configured to implement one or more filtering rules to prevent the private information from being accessed by unauthorized applications on device 402. In this regard, NCI Filter Application 406x may implement one or more Privacy Management Gates to prevent the private information from being transferred out of NFC Controller 406 to an unauthorized reader on Application Processor 104, for example.

Information transfer from Card 120 to reader or device 402 may conventionally follow an Application Protocol Data Unit (APDU) format, such as specified in the ISO7816-4 standard. Filtering rules may be applied to different NCI interfaces by referring to the APDU format in one non-limiting but illustrative example. For instance, one or more rules may be applied to one or more interfaces (e.g., a single interface, a list of a subset of interfaces, all interfaces, etc.). As previously mentioned with reference to FIG. 2, device 102 may provide a SELECT command (e.g., SELECT “2PAY.SYS.DDF01”) to Card 120, the SELECT command to access PPSE 128 on Card 120 in order to determine an Application Identifier (AID) of the payment information to be used, and in response, receive an FCI Template (e.g., FCI Template 206) from PPSE 128 on Card 120, wherein, the FCI Template comprises the private or sensitive information.

To prevent the private information from being accessed by unauthorized applications on device 402, one or more filtering rules may be implemented to filter the private information when the SELECT command is initiated by an unauthorized reader application device 102. In an example, the one or more filtering rules may include, for a SELECT command issued by an unauthorized reader or application on device 402, blocking one or more AIDs to be returned to the unauthorized reader, e.g., a new rule may be added to block SELECT of specified AIDs. The one or more AIDs may comprise Registered Application Provider Identifier (RID)s for which there are greater than a threshold number of Proprietary Application Identifier Extensions (PIX), or one or more specified RIDs of a set of one or more RIDs. In this regard, pattern matching may be implemented such that, for example, matches for specified RID values used in payment, or RIDs for which there may be many different values of PIX (e.g., greater than a pre-specified threshold number of PIX), may be blocked.

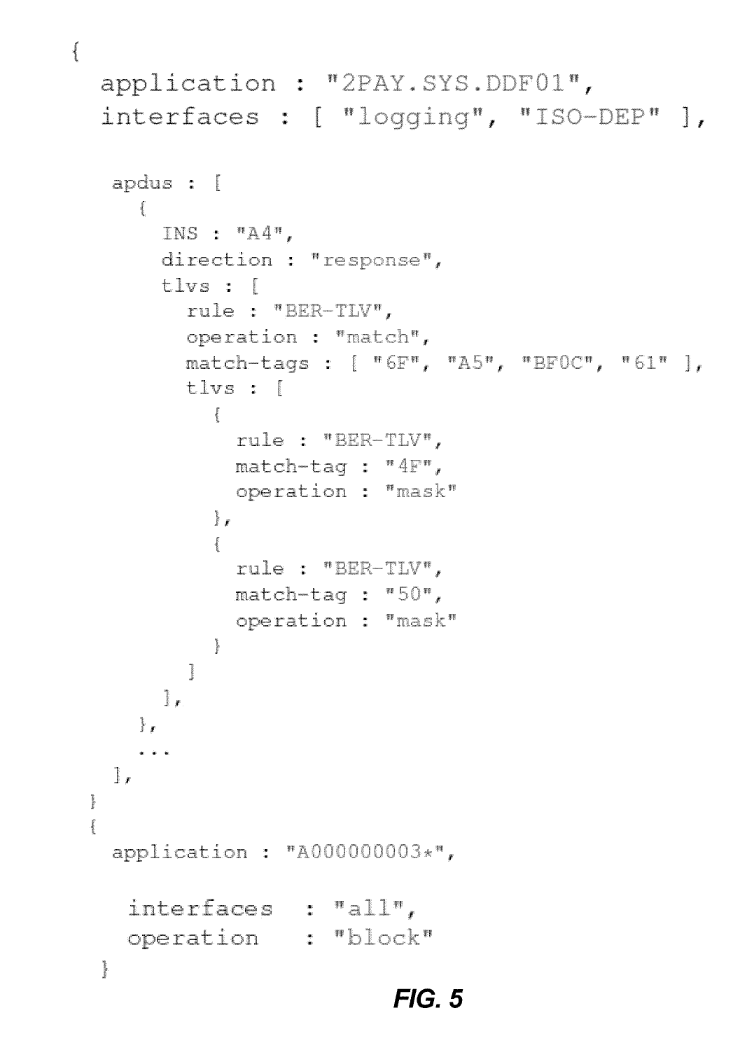

With a brief departure from FIG. 4 to FIG. 5, an example rule set expressed in JavaScript Object Notation (JSON) code is shown, wherein FIG. 5 illustrates the following rules defined: (1) filtering on the logging and ISO-DEP interfaces for the PPSE (AID “2PAY.SYS.DDF01”), which hides sensitive FCI data at NCI interfaces; and (2) defining that any application with RID A000000003 is blocked on all NCI interfaces.

Returning to FIG. 4, APDU filtering may also be implemented in system 400, NCI Filter Application 406x, for example, as a “Poll Mode Routing Table” in the NCI specification.

Additionally, system 400 also includes Privacy Management Gates 408x and 414x respectively added to NFC Controller 406 and Secure Element 412. HCI Host Controller 406b is configured to support Privacy Management Gate 408x. HCI Host Controller 406b may be configured to determine whether support for the Privacy Management Gate 408x exists on any other connected Host by sending the command ANY_GET_PARAMETER (GATES_{LIST}), wherein Privacy Management Gate 408x will be included in the list of gates returned by any Host which supports it.

Privacy Management Gate 408x coupled to HCI Host Controller 406b may provide a mechanism, such as a registry entry, to indicate to an attached host, which filtering mechanisms it supports. This enables, for example, inexpensive NFC Controllers to implement only a subset of the rule types discussed above. For example, NFC Controller 406 may support blocking of only SELECT by AID, while enabling Secure Element 412 to tailor the rules it generates to the capability of NFC Controller 406.

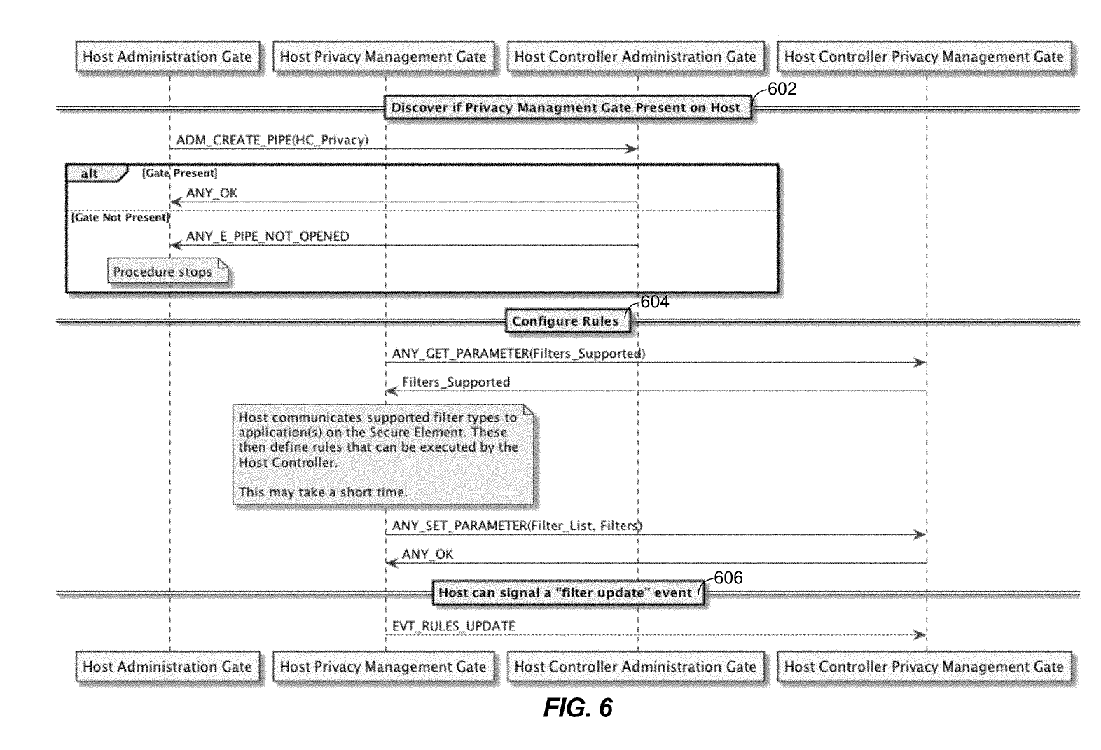

With reference to FIG. 6, a discovery mechanism which may be used by a Host is shown. Using the protocol identified in the block labeled as Discover if Privacy Management Gate Present on Host 602, Privacy Management Gate 408x, may be discovered on device 402 or an HCI Host (specifically in NFC Controller 406). Using the protocol labeled Configure Rules 604, the filtering rules may be configured at Privacy Management Gate 408x. The HCI Host may provide a mechanism, such as a registry entry, to allow HCI Host Controller 406b to read the rules the HCI Host defines. The filtering rules may be updated using a filter update event shown in block 606. Since the rules defined by a Host may depend on the capability of the Host Controller, the discovery mechanism shown in FIG. 6, or equivalents thereof, may be used.

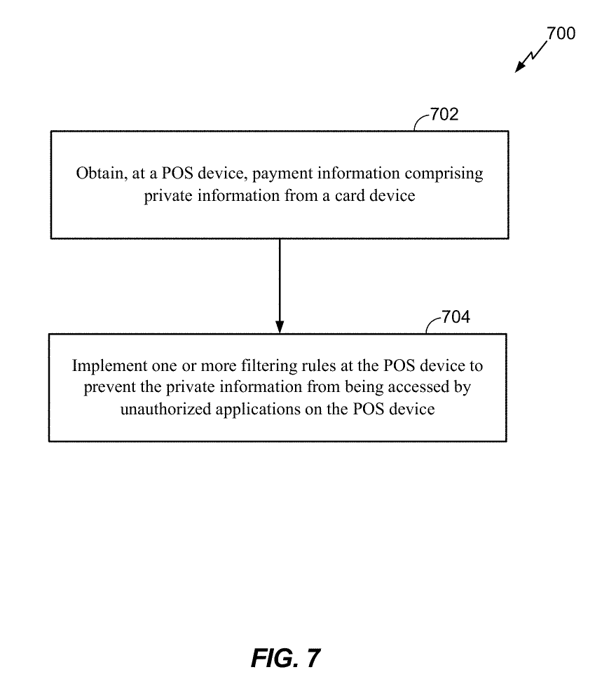

Accordingly, it will be appreciated that aspects include various methods for performing the processes, functions and/or algorithms disclosed herein. For example, as illustrated in FIG. 7, an aspect can include method 700 of protecting private information in a Point of Sale device.

Block 702 comprises obtaining, at the POS device (e.g., device 402 of system 400), payment information (e.g., using NFC communication) comprising private information from a card device (e.g., card 120).

Block 704 comprises, implementing one or more filtering rules at the POS device to prevent the private information from being accessed by unauthorized applications on the POS device (e.g., implementing the one or more filtering rules at NCI Filter Application 406x).

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The foregoing disclosed devices and methods are typically designed and are configured into GDSII and GERBER computer files, stored on a computer-readable media. These files are in turn provided to fabrication handlers who fabricate devices based on these files. The resulting products are semiconductor wafers that are then cut into semiconductor die and packaged into a semiconductor chip. The chips are then employed in devices described above.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of protecting private information in a Point of Sale (POS) device, the method comprising:
obtaining, at the POS device, payment information comprising private information from a card device; and
implementing one or more filtering rules at the POS device to prevent the private information from being accessed by unauthorized applications on the POS device.

2. The method of claim 1, wherein obtaining the payment information at the POS device comprises:
providing a SELECT command to the card device, the SELECT command to access a Proximity Payment Service Environment (PPSE) application on the card device for determining an Application Identifier (AID) of the payment information; and
receiving a File Control Information (FCI) Template from the PPSE application on the card device, the FCI Template comprising the private information.

3. The method of claim 2, wherein implementing the one or more filtering rules comprises filtering the private information when the SELECT command is initiated by an unauthorized reader application on the POS device.

4. The method of claim 2, wherein implementing the one or more filtering rules comprises, for a SELECT command issued by an unauthorized reader, blocking one or more AIDs to be returned to the unauthorized reader.

5. The method of claim 4, wherein the one or more AIDs comprise Registered Application Provider Identifier (RID)s for which there are greater than a threshold number of Proprietary Application Identifier Extensions (PIX).

6. The method of claim 5, wherein the one or more AIDs comprise one or more specified Registered Application Provider Identifier (RID)s of a set of one or more RIDs.

7. The method of claim 2, wherein implementing the one or more filtering rules comprises, filtering contents of a “Track 2 Equivalent Data” Tag Length Value (TLV) issued from an unauthorized reader application.

8. The method of claim 1, comprising obtaining the payment information by Near Field Communication (NFC) with the card device.

9. The method of claim 8, comprising implementing the one or more filtering rules in a NFC Controller Interface (NCI) Filter Application on a NFC Controller of the POS device.

10. The method of claim 9, further comprising configuring one or more Privacy Management Gates of the NCI Filter Application to prevent the private information from being transferred out of the NFC Controller to an unauthorized reader.

11. An apparatus comprising:
a Point of Sale (POS) device in communication with a card device, wherein the POS device is configured to:
obtain payment information comprising private information from the card device; and
implement one or more filtering rules to prevent the private information from being accessed by unauthorized applications on the POS device.

12. The apparatus of claim 11, wherein, to obtain the payment information, the POS device is configured to:
provide a SELECT command to the card device, the SELECT command to access a Proximity Payment Service Environment (PPSE) application on the card device to identify an Application Identifier (AID) of the payment information; and
receive a File Control Information (FCI) Template from the PPSE application on the card device, wherein the FCI Template comprises the private information.

13. The apparatus of claim 12, wherein the one or more filtering rules comprise filtering the private information when the SELECT command is initiated by an unauthorized reader application on the POS device.

14. The apparatus of claim 12, wherein the one or more filtering rules comprises, for a SELECT command issued by an unauthorized reader, to block one or more AIDs to be returned to the unauthorized reader.

15. The apparatus of claim 14, wherein the one or more AIDs comprise Registered Application Provider Identifier (RID)s for which there are greater than a threshold number of Proprietary Application Identifier Extensions (PIX).

16. The apparatus of claim 15, wherein the one or more AIDs comprise one or more specified Registered Application Provider Identifier (RID)s of a set of one or more RIDs.

17. The apparatus of claim 12, wherein the one or more filtering rules comprises, filtering contents of a “Track 2 Equivalent Data” Tag Length Value (TLV) issued from an unauthorized reader application.

18. The apparatus of claim 11, the communication comprises a Near Field Communication (NFC) with the card device.

19. The apparatus of claim 18, wherein the POS device comprises a NFC Controller, wherein the NFC Controller comprises an NFC Controller Interface (NCI) Filter Application configured to implement the one or more filtering rules.

20. The apparatus of claim 19, wherein the NCI Filter Application further comprises one or more Privacy Management Gates configured to prevent the private information from being transferred out of the NFC Controller to an unauthorized reader.

21. An apparatus comprising:
means for performing a Point of Sale (POS) transaction, comprising means for obtaining payment information comprising private information from means for storing payment information; and
means for implementing one or more filtering rules at the means for performing the POS transaction to prevent the private information from being accessed by unauthorized applications on the means for performing the POS transaction.

22. A non-transitory computer-readable storage medium comprising code, which, when executed by a processor, causes the processor to perform operations for protecting private information in a Point of Sale (POS) device, the non-transitory computer-readable storage medium comprising:
code for obtaining, at the POS device, payment information comprising private information from a card device; and
code for implementing one or more filtering rules at the POS device to prevent the private information from being accessed by unauthorized applications on the POS device.

23. The non-transitory computer-readable storage medium of claim 22, wherein the code for obtaining the payment information at the POS device comprises:
code for providing a SELECT command to the card device, the SELECT command to access a Proximity Payment Service Environment (PPSE) application on the card device for determining an Application Identifier (AID) of the payment information; and
code for receiving a File Control Information (FCI) Template from the PPSE application on the card device, the FCI Template comprising the private information.

24. The non-transitory computer-readable storage medium of claim 23, wherein the code for implementing the one or more filtering rules comprises code for filtering the private information when the SELECT command is initiated by an unauthorized reader application on the POS device.

25. The non-transitory computer-readable storage medium of claim 23, wherein the code for implementing the one or more filtering rules comprises, for a SELECT command issued by an unauthorized reader, code for blocking one or more AIDs to be returned to the unauthorized reader.

26. The non-transitory computer-readable storage medium of claim 25, wherein the one or more AIDs comprise Registered Application Provider Identifier (RID)s for which there are greater than a threshold number of Proprietary Application Identifier Extensions (PIX).

27. The non-transitory computer-readable storage medium of claim 26, wherein the one or more AIDs comprise one or more specified Registered Application Provider Identifier (RID)s of a set of one or more RIDs.

28. The non-transitory computer-readable storage medium of claim 23, wherein the code for implementing the one or more filtering rules comprises, code for filtering contents of a “Track 2 Equivalent Data” Tag Length Value (TLV) issued from an unauthorized reader application.

29. The non-transitory computer-readable storage medium of claim 22, comprising code for obtaining the payment information by Near Field Communication (NFC) with the card device and code for implementing the one or more filtering rules in a NFC Controller Interface (NCI) Filter Application on a NFC Controller of the POS device.

30. The non-transitory computer-readable storage medium of claim 29, further comprising code for configuring one or more Privacy Management Gates of the NCI Filter Application to prevent the private information from being transferred out of the NFC Controller to an unauthorized reader.
